(19) United States
(12) Patent Application Publication
(10) Pub. No.: US 2010/0053598 A1
(43) Pub. Date: Mar. 4, 2010

(54) SURFACE DEFORMATION DETECTION

(76) Inventors: Sunghoon Kwon, Seoul (KR); Su Eun Chung, Seoul (KR)

Correspondence Address: Sunghoon Kwoon;Faculty APT 122I-104, San 4-2, Bongchun 7 Dong, Gwanak-GU, Seoul, KR

(21) Appl. No.: 12/199,614

(22) Filed: Aug. 27, 2008

(51) Int. Cl. G01B 11/16

(52) U.S. Cl. 356/32

(57) ABSTRACT

A method of detecting deformation in a substrate includes detecting one or more changes in one or more emission characteristics of at least one pair of plasmon-coupled nanoparticles associated with a substrate, where the substrate includes at least one pair of plasmon-coupled nanoparticles. An apparatus for deformation detection includes a detection unit for detecting one or more changes in one or more emission characteristics of at least one pair of plasmon-coupled nanoparticles associated with a substrate.

### BACKGROUND

Optical characteristics of metal have been studied for a long time. The discovery of surface-enhanced Raman scattering of molecules near metal structures has renewed interest in plasmon resonances of metal particles. The plasmon resonance wavelength depends on a refractive index of the surroundings of metal particles, and the plasmon resonance wavelength of metal nanoparticles is influenced by other nanoparticles surrounding the nanoparticle.

Meanwhile, in micro electro mechanical systems (MEMS) or micro system technique (MST), sensors and actuators have been developed based on micro cantilever technologies. In a micro cantilever, mechanical and physical conversion linked to a chemical or bio-molecular reaction can be used to detect if a chemical or bio-molecular reaction occurs.

The micro cantilever technologies have shown many advantages in comparison with methods using existing dyes and a traditional sensing method. For example, a bio-molecular reaction event can be detected without tagging a display material, such as dyes or fluorescent material, to a molecule. However, the technologies based on a micro cantilever have problems of limitation of detection sensitivity, a high cost for detection, etc.

### SUMMARY

In one aspect, a method of detecting deformation in a substrate is provided, including detecting one or more changes in one or more emission characteristics of at least one pair of plasmon-coupled nanoparticles associated with a substrate; where the substrate includes at least one pair of plasmon-coupled nanoparticles. In some embodiments, the detecting includes measuring a first emission wavelength from the at least one pair of plasmon-coupled nanoparticles; applying electromagnetic energy to the substrate; measuring a second emission wavelength from the at least one pair of plasmon-coupled nanoparticles; and comparing the first emission wavelength to the second emission wavelength to determine the one or more changes in the one or more emission characteristics. In some embodiments, the detecting includes detecting one or more changes in a color emitted from the at least one pair of plasmon-coupled nanoparticles before and after the application of a visible light source. In some embodiments, the detecting includes detecting one or more changes in the wavelength of the energy emitted from the at least one pair of plasmon-coupled nanoparticles before and after the application of an electromagnetic energy source.

In some embodiments, the method further includes determining an extent of deformation of the substrate according to the detected one or more changes in the color emitted from the at least one pair of plasmon-coupled nanoparticles. In some embodiments, the nanoparticles in the pair are coupled with a linker. In some embodiments, the linker includes a DNA, RNA, protein, or peptide linker. In some embodiments, the pair of nanoparticles is associated with the substrate by being attached to a surface of the substrate. In some embodiments, the pair of nanoparticles is associated with substrate by being embedded in the substrate.

In some embodiments, the one or more emission characteristics of at least one pair of plasmon-coupled nanoparticles are changed when the distance between the nanoparticles of the pair is changed. In some embodiments, the detecting includes applying an electromagnetic energy to the pair of nanoparticles; and detecting a shift in wavelength of an optical spectrum of the at least one pair of nanoparticles. In some embodiments, a magnitude of the shift is related to the distance between the nanoparticles of the pair.

In some embodiments, the nanoparticles include a metal. In some embodiments, the metal is gold, silver, copper, titanium, chromium, or a mixture of any two or more thereof. In some embodiments, the nanoparticles include silver, and the detecting includes detecting a red-shift of a wavelength when the distance of the nanoparticles of the pair decreases, or a blue-shift of a wavelength in spectrum when the distance of the nanoparticles of the pair increases.

In another aspect, a method for strain measurement is provided, including detecting a first color emitted from at least one pair of plasmon-coupled nanoparticles associated with a substrate; detecting a second color of emitted from the at least one pair of plasmon-coupled nanoparticles when the substrate is deformed; and comparing the first and second colors. In some embodiments, the at least one pair of nanoparticles are associated with the substrate by being attached to a surface of the substrate or by being embedded in the substrate. In some embodiments, the at least one pair of nanoparticles are joined by a linker that is a DNA, RNA, protein, or peptide linker.

In another aspect, an optical strain measurement device is provided, including an optical energy source; and a detection unit for detecting a strain of a substrate.

In another aspect, an apparatus for deformation detection is provided including a detection unit for detecting one or more changes in one or more emission characteristics of at least one pair of plasmon-coupled nanoparticles associated with a substrate. In some embodiments, the apparatus further includes an optical energy source to apply an optical energy to the at least one pair of plasmon-coupled nanoparticles to detect the emission characteristics. In some embodiments, the apparatus further includes a processor configured to receive, process, store, or transmit values related to the emission characteristics detected by the detection unit.

In another aspect, a sensor is provided including a membrane disposed on a substrate, the membrane having an exterior surface; and at least one pair of plasmon-coupled nanoparticles associated with the exterior surface of the membrane. In some embodiments, the exterior surface includes a reaction agent for interacting with a reaction medium in a manner to deflect the membrane relative to the substrate. In some embodiments, the deflection of the membrane relative to the substrate is detected by one or more changes in one or more emission characteristics of the at least one pair of plasmon-coupled nanoparticles.

In some embodiments, the reaction agent includes a chemical or biomolecular reaction agent. In some embodiments, the reaction medium includes an analyte. In some embodiments, the membrane includes a polymer membrane, or an elastomeric membrane. In some embodiments, the pair of nanoparticles are associated with a linker. In some embodiments, the linker includes a DNA, a RNA, a protein, or a peptide linker. In some embodiments, the nanoparticles include gold, silver, copper, titanium, chromium, or a combination of any two or more thereof. In some embodiments, the membrane has a convex or concave shape.

In another aspect, a thin membrane transducer is provided including: a membrane connected to a substrate, the membrane having an exterior surface including a reaction agent for interacting with a medium in a manner to deflect the membrane relative to the substrate; and at least one pair of plasmon-coupled nanoparticles associated with the exterior surface of the membrane. In some embodiments, the deflection of the membrane is determined by one or more emission characteristics of the at least one pair of plasmon-coupled nanoparticles. In some embodiments, the at least one pair of plasmon-coupled nanoparticles are optically observable. In some embodiments, the nanoparticles include gold, silver, copper, titanium, chromium, or a mixture of any two or more thereof.

In another aspect, a method for detecting deflection of a membrane is provided including: detecting optical characteristics of at least one pair of plasmon-coupled nanoparticles associated with an exterior surface of a membrane, where the optical characteristics of the at least one pair of plasmon-coupled nanoparticles change in response to the deflection of the membrane. In some embodiments, the deflection of the membrane is the result of an interaction between a reaction agent on the exterior surface of the membrane with an analyte. In some embodiments, the detecting optical characteristics of at least one pair of plasmon-coupled nanoparticles includes providing an electromagnetic energy to the plasmon-coupled nanoparticles, and detecting one or more changes in color emitted from the at least one pair of plasmon-coupled nanoparticles. In some embodiments, the detecting includes providing an electromagnetic energy to the plasmon-coupled nanoparticles and detecting one or more changes in the wavelength of the energy emitted from the at least one pair of plasmon-coupled nanoparticles. In some embodiments, the membrane is deflected in response to a chemical or biomolecular reaction. In some embodiments, the membrane includes an elastomeric membrane. In some embodiments, the nanoparticles include gold, silver, copper, titanium, chromium, or a mixture of any two or more thereof.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1A and 1B are schematic illustrations of a substrate and associated nanoparticle pairs prior to deformation (FIG. 1A), and post deformation (FIG. 1B), according to some illustrative embodiments.

FIG. 2 is a schematic illustration of a nanoparticle pair, according to one illustrative embodiment.

FIG. 3A is a schematic of an illustrative embodiment showing the change in the distance between particles of a nanoparticle pair associated with the deformation of a substrate.

FIG. 3B is a graph showing the shift in the spectral wavelength of a nanoparticle pair associated with a change in the distance between particles, according to one illustrative embodiment.

FIGS. 4A and 4B are schematic drawings of a substrate and associated nanoparticle pairs, according to some illustrative embodiments.

FIG. 5 is a flow chart illustrating a substrate deformation detection method, according to one illustrative embodiment.

FIGS. 6 and 7 are schematic illustrations of a membrane and associated nanoparticle pairs prior to deflection (FIG. 6), and post deflection (FIG. 7), according to some illustrative embodiments.

FIG. 8 is a graph showing a shift in the spectral wavelength of a nanoparticle pair associated with a deflection of a membrane, according to one illustrative embodiment.

FIG. 9 is a flow chart showing a membrane deflection detecting method, according to one illustrative embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

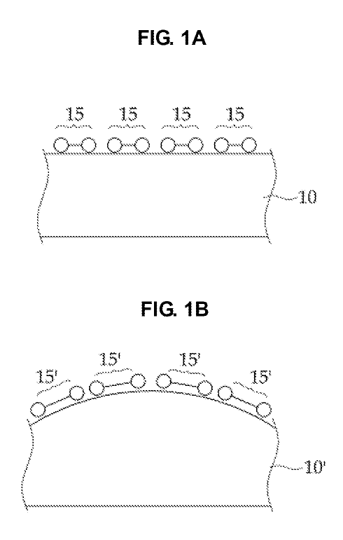

FIG. 1A schematically illustrates a substrate and associated nanoparticle pairs. With reference to FIG. 1A, nanoparticle pairs 15 are associated with a surface of a substrate 10. The substrate 10 is composed of a material which can be deformed and which allows nanoparticle pairs to be associated therewith. The substrate 10 includes, but is not limited to, a ceramic, glass, plastic, and/or semiconductor substrate and/or layer. The substrate 10 is deformable in response to an external force, which causes a change in the strain on the surface and/or the inside of the substrate. The external force may be the result of one or more events, including but not limited to, physical, thermal, or chemical events, for example.

The nanoparticles may include a metal suitable for plasmon coupling such as, but not limited to, gold, silver, copper, titanium, or chromium. Plasmon coupling is a phenomenon where two metal nanoparticles are brought into proximity their plasmons couple. The proximity for plasmon coupling may be about 3 times the particle diameter or less, particularly about 2.5 times the particle diameter or less. The shape of the nanoparticles includes, but is not limited to, spherical, tetrahedral, cubic, or cylindrical. In some embodiments, the size (average diameter) of the nanoparticles is from about 10 nm to 100 nm. In other embodiments, the size of the nanoparticles is from about 20 nm to 60 nm. By way of example only, the shape of a silver nanoparticle is a sphere and the size of the silver nanoparticle is from about 20 nm to 50 nm. By way of example only, the shape of a gold nanoparticle is a sphere and the size of the gold nanoparticle is from about 30 nm to 50 nm.

In one embodiment, the nanoparticle pairs 15 are attached to a surface of the substrate. For example, aqueous solutions of nanoparticles can be provided so as to be attached to the surface of the substrate 10. The nanoparticles can be attached to the surface of the substrate 10 via weak van der Waals interactions, hydrogen bond interactions, or strong ionic and covalent bond interactions. These interactions can be examples of various associations between the nanoparticles and the substrate.

Two nanoparticles undergo plasmon coupling when they are brought into proximity. Plasmon coupling results in a wavelength shift, with the amount of the shift depending on the distance between the particles. The wavelength shift resulting from plasmon coupling is optically observable. Electromagnetic energy such as visible light, white light, infrared ray, ultraviolet ray or X-ray, may be used to excite the plasmon-coupled nanoparticles and thereby detect any change or shift in the wavelength. When an electromagnetic energy source, for example, unpolarized white light is applied to plasmon-coupled nanoparticles, the light emitted by the plasmon-coupled nanoparticles may be observed through an optical detection device such as a microscope, such as, a darkfield microscope.

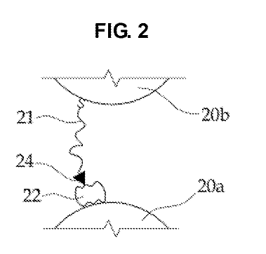

FIG. 2 is a schematic illustration of a pair of plasmon-coupled nanoparticles that are connected through a linker 21. The linker 21 is optionally any material that places the two nanoparticles within the appropriate proximity for plasmon coupling. For example, the appropriate proximity is from about 1 nm to 300 nm, from about 2 nm to 250 nm, or from about 10 nm to 100 nm, according to various embodiments. In addition, the appropriate proximity can be up to about 3 times the particle diameter. Such linkers 21 may include, but are not limited to, nucleic acid linkers (e.g. single-stranded DNA (ssDNA), double-stranded DNAs (dsDNAs), cDNAs, mRNAs, rRNAs, oligonucleotides), protein linkers (e.g. peptides), antibodies (e.g. monoclonal or polyclonal), aptamers, and/or any natural and/or non-natural modifications or derivatives thereof. In some embodiments, the length of the linker from about 1 nm to 300 nm, from about 2 nm to 250 nm, or about 10 nm to 100 nm.

Methods for making nanoparticle pairs connected through linkers 21 include, but are not limited to, immobilizing one or more first nanoparticles 20a on one or more surfaces of one or more substrates. In one embodiment, one or more of the first nanoparticles 20a are coated with streptavidin 22. For example, coating the first nanoparticles 20a with streptavidin 22 includes adding a streptavidin solution to an aqueous nanoparticle solution. The streptavidin solution can be prepared by dissolving streptavidin in a buffer, such as T50 buffer (10 mM Tris, pH 8.0 and 50 mM NaCl). The first nanoparticles 20a coated with streptavidin 22 are attached to the surface of the substrate coated with biotin through streptavidin-biotin binding. In one embodiment, one or more second nanoparticles 20b associated with a linker 21 are provided to the substrates having the one or more first nanoparticles 20a immobilized on the surface thereof. In other embodiments, a 33-nucleotide ssDNA linker having biotin 24 at the unbound end is bound to the one or more immobilized nanoparticles 20a coated with streptavidin 22.

With reference to FIG. 1B, a substrate 10′ having a deformed surface (e.g. a convex shape) is illustrated. However, the substrate surface can also be deformed into a concave shape, and the interior of the substrate can also be deformed due to strain. As described above, such deformation of the substrate 10′ can be detected through optical observation of a wavelength shift of plasmon-coupled nanoparticle pairs 15′.

In illustrative embodiments, as the shape of the substrate 10 changes (e.g. deforms to convex 10′ and/or concave), a distance between the plasmon-coupled nanoparticles 15 changes. As the shape of the substrate 10 changes into the shape of the substrate 10′, a distance between the plasmon-coupled nanoparticles 15′ increases. Conversely, is the substrate 10 changes into a concave shape, the distance between the Plasmon-coupled nanoparticles would decrease. The change of the distance between the plasmon-coupled nanoparticles 15′ causes a change in the plasmon coupling between the nanoparticles resulting in a spectral shift of a characteristic wavelength. For example, if the substrate 10 changes into a convex shape as shown in FIGS. 1A and 1B, the increased distance between the plasmon-coupled nanoparticles results in blue-shifted (toward left) in spectrum. If the substrate 10 changes into a concave shape (not shown), the decreased distance between the plasmon-coupled nanoparticles results in red-shifted (toward right) in spectrum. Such a shift is may be detected when an electromagnetic energy source provides electromagnetic energy at a certain wavelength to the Plasmon-coupled nanoparticle pair 15′. For example, if white light illuminates the plasmon coupled nanoparticle pair 15′, the emitted wavelength of the plasmon coupled nanoparticle pair 15′ shifts by about Δ5 nm to Δ200 nm, by about Δ10 nm to Δ150 nm, or by about Δ15 nm to Δ100 nm, or more, according to the various embodiments. By way of example only, if the wavelength of the plasmon-coupled nanoparticle pair shifts by about from Δ1 nm to Δ65 nm, the distance change of particles can be determined to be from about Δ0.3 nm to Δ30 nm linearly.

As one, non-limiting example, when a plasmon-coupled nanoparticle pair 15 is silver, as the distance between the nanoparticles 15′ in a pair associated with the deformed substrate 10′ increases the wavelength of the nanoparticle pair 15′ is blue-shifted in the spectrum. For example, if the wavelength of the silver, plasmon-coupled nanoparticles is about 550 nm, a shift of 102 nm is observed. In such a case, the emitted color changes from green to blue.

As another, non-limiting example, a plasmon-coupled nanoparticle pair is gold, as the distance between the nanoparticles in the pair wavelength increases, the wavelength of the nanoparticle pair shifts from about 570 nm by about 23 nm. The observed color change is from orange to dark green.

Other metal nanoparticles, which include, but are not limited to gold, copper, titanium, or chromium, show similar tendencies for wavelength shifts as the silver nanoparticle. That is, a red-shift for reduced distance of plasmon-coupled nanoparticles and blue-shift for increased distance of plasmon-coupled nanoparticles is observed. In some embodiments, visible rays illuminate silver or gold nanoparticles and derive color emission of the nanoparticles. The color emission of the silver or gold nanoparticles can be detected by dark field microscopes. In some embodiments, other electromagnetic radiation sources, such as but not limited to, X-rays, lasers, and infrared sources can be used for illuminating metal nanoparticles to detect their color emission.

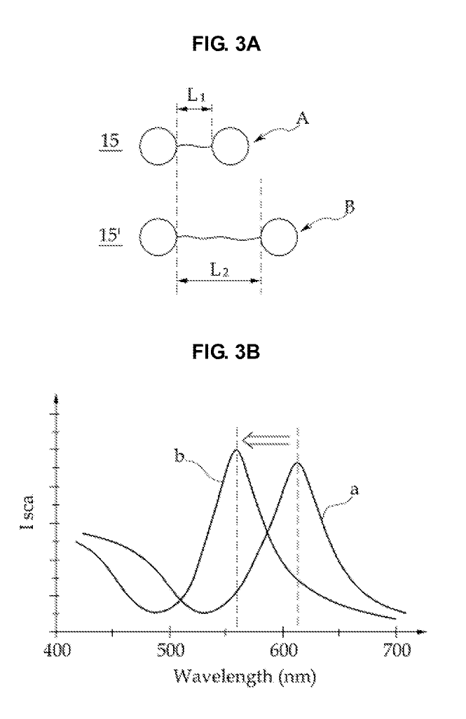

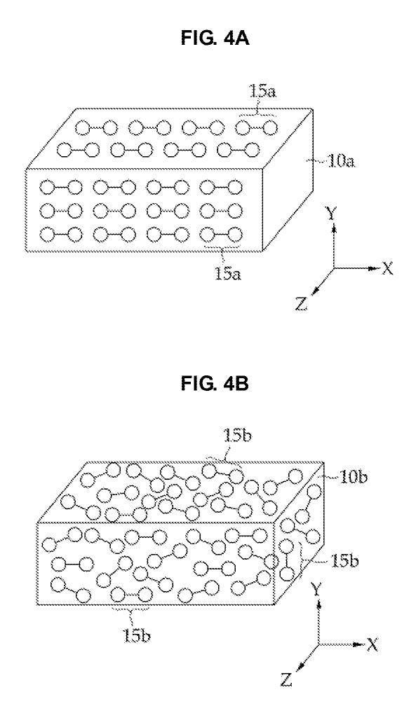

FIG. 3A is a schematic representation illustrating the impact of the change in the distance between plasmon-coupled nanoparticles to the change of optical characteristics (e.g. wavelength shift as shown in FIG. 3B). FIG. 3A shows a comparison of the distance, L₁, between the plasmon-coupled particles 15 attached to the substrate 10 (FIG. 1A). The distance between the plasmon-coupled particles 15′ attached to the deformed substrate 10′ is designated as L₂. FIG. 3B shows the spectral shift in the wavelength associated with the change of the distance between the plasmon-coupled particles.

As a non-limiting example, for silver nanoparticles, and as shown in FIG. 3A, when there is no deformation of the substrate 10, the silver nanoparticle pair 15 attached on a surface of the substrate 10 has a distance L₁ between nanoparticles. As shown in FIG. 1B, the surface of the substrate 10′ is deformed into a convex shape (state B) so that the distance between nanoparticles in the nanoparticle pair 15′ increases to be a distance L₂. The state A and B of the nanoparticles shown in FIG. 3A can be detected as shown in FIG. 3B. With reference to FIG. 3B, a curved line of a wavelength spectrum a in a case where the distance between the Ag nanoparticles 15 is L1, and a curved line of a wavelength spectrum b in a case where the distance between the Ag nanoparticles 15′ is L2 are illustrated. As shown, as the distance between the nanoparticles is increased from L1 to L2, the extent of plasmon-coupling decreases. Accordingly, the wavelength spectrum is shifted to lower wavelength. The scattering color of the nanoparticles varies corresponding to the change in wavelength when it is observed by an optical detection device. For example, assume that the color of the nanoparticles is yellow (state A illustrated in FIG. 3A). If the distance between the nanoparticles increases as in the state B, the color of the nanoparticles is blue-shifted in wavelength, resulting in a change to a green color. If the distance becomes smaller, the wavelength is red-shifted. As a result, it is possible to detect if the substrate, to which nanoparticles are attached, is deformed. As such, according to an illustrative embodiment, substrate deformation or strain change of a substrate can be easily detected through emission spectrum detection of plasmon-coupled nanoparticles associated therewith. Further, the quantitative surface deformation can be measured by using the relationship between the wavelength shift and the distance between the particles in a pair, as described above.

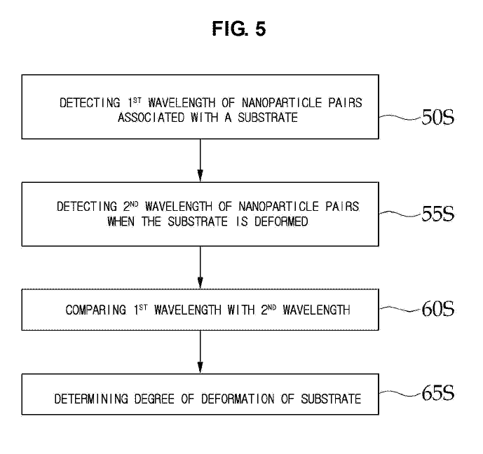

FIGS. 4A and 4B are schematic illustrations of substrates associated with plasmon-coupled nanoparticles. The plasmon-coupled particles 15a, 15b are embedded in a substrate 10a, 10b as well as optionally present on one or more surfaces of the substrate. As such, in a case where nanoparticle pairs are disposed within the substrate, the change of the strain within the substrate can also be detected.

As shown in FIG. 4A, a plurality of nanoparticle pairs 15a can be arranged at a predetermined interval in a substrate 10a. Also, as described above, a linker connected between the nanoparticles 15a may be a linker, such as a nucleic acid linker (e.g., single-stranded DNA (ssDNA), double-stranded DNAs (dsDNAs), cDNAs, mRNAs, rRNAs, oligonucleotides), a protein linker (e.g. peptides), an antibody (e.g. monoclonal or polyclonal), and/or an aptamer. The linkers connected between each nanoparticle pair 15a can have the same length so as to secure a uniform distance between nanoparticles. Then, if a portion of the substrate 10a is deformed, the distance between the nanoparticles 15a in a pair, which are embedded in the deformed portion, is changed, thereby causing the change of an optical characteristic thereof. As a result, it is possible to detect which portion of the substrate 10a is deformed. FIG. 4A illustrates an embodiment where the nanoparticle pairs 15a are arranged in an X-axial direction. However, they can be also arranged in a Y-axial direction, in a Z-axial direction, and or any intermediate axial direction.

In another embodiment, as shown in FIG. 4B, multiple nanoparticle pairs 15b can be arranged within a substrate 10b in random directions. As such, in a case where multiple nanoparticle pairs 15b are embedded within the substrate 10b in the random directions, it is possible to determine which portion of the substrate is deformed, and also to detect a direction of strain exerted to the substrate. For example, assume the same material nanoparticle pairs 15b having the same spacing between particles in a pair are arranged in different directions in the substrate 10b. If the strain of a specific region the inside or the surface of the substrate 10b is changed, the optical characteristics of the nanoparticle pairs associated with the specific region are changed. Therefore, the change can be detected by an optical detection unit.

The arrangement shape, arrangement direction, and the interval between nanoparticles of nanoparticle pairs of the above-described nanoparticle pairs 15a, 15b are not limited to the above described embodiment. They can be implemented in any arrangement according to intention of a designer without limitation.

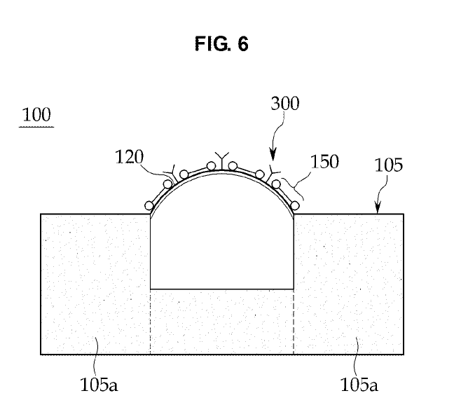

FIG. 5 is a flow chart of a method for detecting the deformation of a substrate according to an embodiment. In box 50S, an electromagnetic energy such as visible light, infrared ray, ultraviolet ray or X-ray is applied to at least one nanoparticle pair associated with the substrate so as to detect a first wavelength of the nanoparticle pair. If the substrate is deformed, a distance between the nanoparticles is changed. Further, according to the distance change between the nanoparticles, plasmon coupling characteristic is changed, so that the wavelength is shifted in spectrum. After substrate deformation, a second wavelength of the nanoparticle pair is detected in step 55s. Step 60S is a comparison of the first wavelength to the second wavelength. If the second wavelength has been red-shifted in comparison with the first wavelength, the decrease in distance between the nanoparticles can be determined. Likewise, if the second wavelength has been blue-shifted in comparison with the first wavelength, the increase in distance between the nanoparticles can be determined. Because distance changes may be observed by using the plasmon-coupled nanoparticles, such units are referred to as a “plasmon ruler.”

Using such methods, it is possible to detect whether a substrate is deformed or strained by detecting an optical characteristics of plasmon-coupled nanoparticle pairs associated with the substrate.

According to another embodiment, an apparatus for detecting deformation of a substrate, which is configured so as to perform the above-described substrate deformation detecting method, is provided. The apparatus may include at least one nanoparticle pair associated with a substrate, the nanoparticles in the pair being connected with each other through a linker, and a means for detecting the change in optical characteristics of the nanoparticles. As such, the plasmon ruler can be used in detecting if the substrate is deformed or if the strain of the substrate is changed, by applying an optical energy to the nanoparticle pairs associated with a substrate through an optical energy source, and detecting the scattering color of the nanoparticle pairs or plasmon resonance wavelength.

According to one embodiment, a substrate deformation detecting apparatus or an optical strain measurement device includes an electromagnetic energy source, and an optical detection unit such as optical microscope, electron microscope, or darkfield microscope. The optical detection unit detects the scattering color or plasmon resonance wavelength of the nanoparticle pairs associated with a substrate as described with reference to FIGS. 1 through 5. The apparatus may include a processor connected to the optical detection unit so as to receive, process, store, and/or transmit the values detected by the optical detection unit. In one embodiment, the processor compares and analyzes the scattering colors or plasmon resonance wavelengths detected by the optical detection unit. Also, the substrate deformation detecting apparatus may further include a deformation degree determining unit for determining the degree of substrate deformation by using the values detected by the optical detection unit.

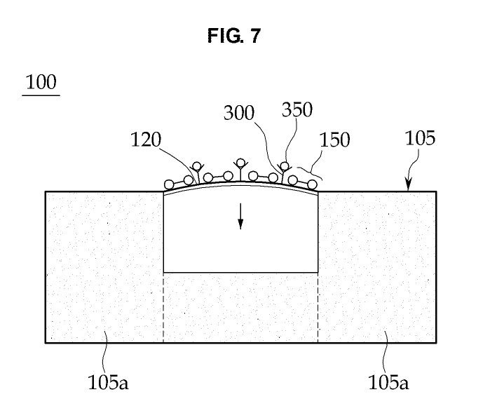

In another embodiment, a thin membrane transducer associated with nanoparticle pairs is described with reference to FIGS. 6 through 9.

FIG. 6 shows a thin membrane transducer 100 associated with nanoparticle pairs 150. The association includes any kind of boding such as weak van der Waals interactions, hydrogen bond interactions, or strong ionic and/or covalent bond interactions between the nanoparticles and the surface of the thin membrane. For example, streptavidin coated nanoparticle pairs can be attached to biotin coated surface of the thin membrane via streptavidin-biotin bonding.

A substrate 105, including substrate sections 105a, is provided. In some embodiments, the substrate sections 105a can be separated from each other. In some embodiments, the substrate sections 105a can be connected with each other as shown in FIG. 6. The substrate 105 can include, but is not limited to, ceramics, glasses, plastics, or semiconductor substrates. By way of example only, the thickness of the substrate 105 may be from about 1 μm to 10000 μm. However, the thickness of the substrate 105 can be designed according to intention of a designer without limitation.

In some embodiments, a thin membrane 120 is connected to the substrate sections 105a. The substrate 105 has a recess 107. The shape of the recess 107 may be, but not limited to, a square opening, corner rounded square opening or a semicircle. The thin membrane 120 can be deformed into a convex or concave shape. The peripheral edges of the thin membrane 120 can be fastened to the substrate 105, for example, by adhesives such as, but not limited to, phenol based adhesives, epoxy based adhesives or rubber based adhesives as known in this art. The portion of the thin membrane 120 positioned over the recessed portion of the substrate 105 is configured to allow freedom of movement so as to have a convex shape or a concave shape respective to the substrate in response to various binding interactions.

The thin membrane 120 may include an elastomeric membrane. For example, the material of the thin membrane 120 can include a elastomeric polymer having low mechanical stiffness (which is the resistance of an elastic body to deflection or deformation by an applied force), such as but not limited to, rubber, latex, or polydimethylsiloxane (PDMS). Also, the material of the thin membrane 120 can include ceramic materials, such as but not limited to, silicon oxide films or silicon nitride films, which have relatively high mechanical stiffness in comparison with the elastomeric polymer. It is easily understood that the material of the thin membrane 120 is not limited to the above described materials if the materials can allow the desired shape of a thin membrane. The thickness of the thin membrane is about 1 nm to 10 82 m, about 1 nm to 1 μm, or about 1 nm to 100 nm, according to various embodiments. The thin membrane 120 may have a circular periphery, a polygonal periphery such as a square periphery or any other peripheral configuration.

Nanoparticle pairs 150 are provided on an exterior surface of the thin membrane 120. For example, the nanoparticle pairs 150 can be attached to the exterior surface of the thin membrane 120 via, for example, streptavidin-biotin bonding.

In some embodiments, aqueous solutions of nanoparticles can be introduced in such a manner that they are attached on the external surface of the thin membrane 120. The introduction of nanoparticles to the external surface of the thin membrane 120 can be referred to as the introduction methods of nanoparticles for the substrate deformation detection part, described above.

A pair of plasmon-coupled nanoparticles that are connected through a linker as shown in FIG. 2 can be employed for association with the exterior surface of the thin membrane 120. FIGS. 6 through 9 show illustrative embodiments for detecting one or more chemical or bio-molecular reactions using the thin membrane transducer 100.

Referring to FIG. 6, a thin membrane transducer 100 may includes a substrate 105 and a thin membrane 120 associated with the nanoparticle pairs 150. In some embodiments, the thin membrane transducer 100 can be used in detecting the occurrence of one or more chemical and/or biomolecular reactions or bindings.

The thin membrane 120 can be manufactured to have a convex shape or a concave shape. In some embodiments, the thin membrane can have a dome-shape as shown in FIG. 6. In some embodiments, a reaction agent is provided onto the exterior surface of the thin membrane 120 to provide binding or reaction sites. For example, a reaction agent 300 can be provided on the convex external surface of the thin membrane 120 so as to provide chemical or bio-molecular binding or reaction sites. The reaction agent 300 can include any molecules for a desired reaction. Further, the external surface of the thin membrane 120 can be partially or completely coated with the reaction agent 300.

In one embodiment, the exterior surface of the thin membrane is coated with chemical and/or biological binding sites and single or multiple chemical and/or biomolecular species in the analyte can be flowed onto the thin membrane. For example, the thin membrane transducer is demonstrated to provide a high-sensitivity, label-free detection of a bioaffinity reaction (biotin-streptavidin). For example, biotin may be immobilized on a gold-coated surface of the dome-shaped membrane using cysteamine and photobiotin. Streptavidin in phosphate buffered saline (PBS) is then added to monitor the reaction. When the streptavidin is added, the inflation of membrane by compressive surface stress is produced by the chemical reaction. Deflection of the membrane can be detected by optically detecting change in optical characteristics such as emitted color of nanoparticle pairs on the exterior surface of the membrane. The thin membrane acts as a transducer that can interpret occurrence of the reaction through molecular binding force by optical detection of the nanoparticle pairs, which is fundamentally different from tagging based approaches.

In some embodiments, reactions that may occur on the thin membrane 120 include, but are not limited to chemical or bio-molecular reactions, adsorption, hydrogen bonding, deposition, self-assembly of a molecular structure, and thermal reactions.

FIG. 7 is an illustration of a thin membrane transducer to which an analyte (medium or sample) for detection is provided. In some embodiments, it is possible to flow the analyte on an exterior surface of the thin membrane 120, such that chemical and/or bio-molecular binding or reactions occur. The analyte can include, but is not limited to, chemical species, molecules or ions 350 for analysis. The analyte can be a liquid or gas containing chemical species for detection. If chemical or bio-molecular reactions occur between reaction agent molecules 300, with which the exterior surface of the thin membrane 120 is coated, and with the molecules 350 of the analyte (medium or sample) introduced to the thin membrane 120, strain on the surface of the thin membrane is changed.

As shown in FIG. 7, the convex shape of the thin membrane 120 can be relieved due to reactions between molecules. The change in strain can be detected through optical observation of plasmon-coupled nanoparticle pairs associated with the thin membrane 120. According to the change in shape of the thin membrane 120, an interparticle distance of the plasmon-coupled nanoparticle pair 150, which is attached to the exterior surface of the thin membrane 120, is changed. In some embodiments, if the shape of the thin membrane 120 illustrated in FIG. 6 (convex shape) is changed into the shape of the thin membrane 120 illustrated in FIG. 7 (relieved convex shape), an interparticle distance of the plasmon-coupled nanoparticle pair is reduced.

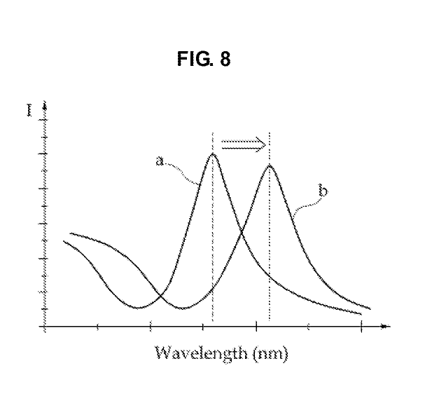

FIG. 8 shows the impact of the change on the distance between plasmon-coupled nanoparticles to the change of optical characteristics (e.g. wavelength shift). Plasmon coupling between two nanoparticles can be optically observed. The color emitted from the plasmon-coupled nanoparticles depends on an interparticle distance. If the interparticle distance is larger, a wavelength is blue-shifted, and if the interparticle distance is smaller, the wavelength is red-shifted. In some embodiments, visible light is used to illuminate silver or gold nanoparticles and derive color emission of the nanoparticles. The color emission of the silver or gold nanoparticles can be detected by dark field microscopes. In some embodiments, other electromagnetic radiation such as but not limited to X-ray, laser, and infrared radiation can be used for illuminating metal nanoparticles to detect their color emission. Therefore, through color detection of nanoparticles, a distance between nanoparticles can be determined. Moreover, deflection of a thin membrane associated with the plasmon-coupled nanoparticles can be determined. As such, the plasmon-coupled nanoparticle pairs connected with each other through a linker can function as a control element for detecting the deflection of a thin membrane.

Referring to FIG. 8, the interparticle distance of the plasmon-coupled nanoparticle pair 150 associated with the thin membrane illustrated in FIG. 6 is detected as the wavelength of curved line, a. The reduced interparticle distance of the plasmon-coupled nanoparticle pair 150 associated with the thin membrane 120 illustrated in FIG. 7 is detected as the wavelength of curved line, b.

As shown in FIG. 8, as the convex dome-shape of the thin membrane 120 is smoother, the interparticle distance of the plasmon-coupled nanoparticle pair 150 decreases. As the interparticle distance decreases, a wavelength is red-shifted. As such, according to some embodiments, the change in strain of a thin membrane or intermolecular reactions occurring on a surface of the thin membrane 120 can be easily detected by using the change in color emitted from the plasmon-coupled nanoparticle pairs 150.

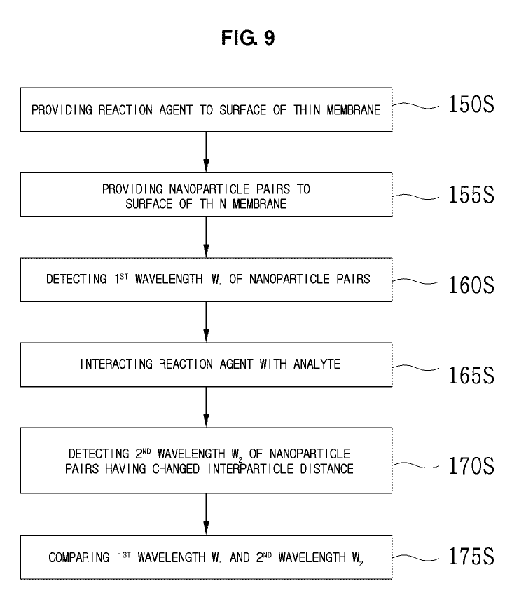

FIG. 9 is a flow chart illustration of a method for detecting if a thin membrane is deflected or if chemical and/or biomolecular reactions occur through a thin membrane transducer, according to one embodiment. A reaction agent is associated with an exterior surface of the thin membrane of the thin membrane transducer so as to detect a desired reaction event 150s. The reaction agent provides binding or reaction sites to the surface of the thin membrane. Plasmon-coupled nanoparticle pairs are associated with the surface of the thin membrane of the thin membrane transducer 155s. In some embodiments, an electromagnetic energy is provided to the plasmon-coupled nanoparticle pairs so as to detect the color emitted from the nanoparticles, that is, an optical spectrum wavelength w1 160s. In some embodiments, if a wavelength detected in step 160s is defined as a first wavelength w1, this can be a wavelength corresponding to curved line, a, in FIG. 8. Then, the reaction agent provided on the surface of the thin membrane is interacted with analyte (medium or sample) optionally containing a target analyte molecule that can interact with the reaction agent 165s. In the presence of a target analyte molecule that interacts with the reaction agent, the thin membrane may be deflected due to a reaction between a molecule of the reaction agent and a molecule of analyte. In order to detect the change of an interparticle distance of the nanoparticle pair associated with the deflection of the thin membrane, an electromagnetic energy is applied to the nanoparticle pair so as to detect an optical spectrum wavelength 170s. The wavelength detected can be defined as, for example, a second wavelength w2. By comparing the first wave length, w1, and the second wavelength, w2, by detecting the change in color emitted from the plasmon-coupled nanoparticle pairs in step 160s and 170s, it is possible to detect if the thin membrane is defected or if chemical and/or biomolecular reactions occurred 175s.

In an illustrative embodiment of a method for detecting, if a thin membrane is deflected, or if intermolecular reaction occurs on the thin membrane transducer, the deflection of the thin membrane or a binding and/or reaction event provided to the thin membrane can be optically observable. This is accomplished through optical detection of plasmon-coupled nanoparticle pairs provided on the surface of the thin membrane.

In some embodiments, the order of the above-described steps of detecting if the thin membrane is deflected or if the reaction event occurs can be changed within the scope showing the above-described effect. For example, the step 50s of providing reaction agent on the exterior surface of the thin membrane of the thin membrane transducer for desired reaction can be performed after the step 55s for providing nanoparticle pairs on the surface of the thin membrane of the thin membrane transducer.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

### Equivalents

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed invention. Additionally the phrase “consisting essentially of” will be understood to include those elements specifically recited and those additional elements that do not materially affect the basic and novel characteristics of the claimed invention. The phrase “consisting of” excludes any element not specifically specified.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof.

Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of detecting deformation in a substrate comprising:
detecting one or more changes in one or more emission characteristics of at least one pair of plasmon-coupled nanoparticles associated with a substrate;
wherein:
the substrate comprises at least one pair of plasmon-coupled nanoparticles.

2. The method of claim 1, wherein the detecting comprises
measuring a first emission wavelength from the at least one pair of plasmon-coupled nanoparticles;
applying electromagnetic energy to the substrate;
measuring a second emission wavelength from the at least one pair of plasmon-coupled nanoparticles; and
comparing the first emission wavelength to the second emission wavelength to determine the one or more changes in the one or more emission characteristics.

3. The method of claim 1, wherein the detecting comprises detecting one or more changes in a color emitted from the at least one pair of plasmon-coupled nanoparticles before and after the application of a visible light source.

4. The method of claim 1, wherein the detecting comprises detecting one or more changes in the wavelength of the energy emitted from the at least one pair of plasmon-coupled nanoparticles before and after the application of an electromagnetic energy source.

5. The method of claim 3 further comprising determining an extent of deformation of the substrate according to the detected one or more changes in the color emitted from the at least one pair of plasmon-coupled nanoparticles.

6. The method of claim 1, wherein the nanoparticles in the pair are coupled with a linker.

7. The method of claim 6, wherein the linker comprises a DNA, RNA, protein, or peptide linker.

8. The method of claim 1, wherein the pair of nanoparticles is associated with the substrate by being attached to a surface of the substrate.

9. The method of claim 1, wherein the pair of nanoparticles is associated with substrate by being embedded in the substrate.

10. The method of claim 1, wherein the one or more emission characteristics of at least one pair of plasmon-coupled nanoparticles are changed when the distance between the nanoparticles of the pair is changed.

11. The method of claim 1, wherein the detecting comprises:
applying an electromagnetic energy to the pair of nanoparticles; and
detecting a shift in wavelength of an optical spectrum of the at least one pair of nanoparticles.

12. The method of claim 11, wherein a magnitude of the shift is linearly related to the distance change between the nanoparticles of the pair.

13. The method of claim 1, wherein the nanoparticles comprise a metal.

14. The method of claim 13, wherein the metal is gold, silver, copper, titanium, chromium, or a mixture of any two or more thereof.

15. The method of claim 3, wherein the nanoparticles comprise silver, and the detecting comprises detecting a red-shift of a wavelength when the distance of the nanoparticles of the pair decreases, or a blue-shift of a wavelength in spectrum when the distance of the nanoparticles of the pair increases.

16. A method for strain measurement, comprising:
detecting a first color emitted from at least one pair of plasmon-coupled nanoparticles associated with a substrate;
detecting a second color emitted from the at least one pair of plasmon-coupled nanoparticles when the substrate is deformed; and
comparing the first and second colors.

17. The method of claim 16 wherein the at least one pair of nanoparticles are associated with the substrate by being attached to a surface of the substrate or by being embedded in the substrate.

18. The method of claim 16 wherein the at least one pair of nanoparticles are joined by a linker that is a DNA, RNA, protein, or peptide linker.

19. An optical strain measurement device comprising:
an optical energy source; and
a detection unit for detecting a strain of a substrate by detecting one or more changes in one or more emission characteristics of at least one pair of plasmon-coupled nanoparticles associated with a substrate, wherein the substrate comprises at least one pair of plasmon-coupled nanoparticles.

20. An apparatus for deformation detection comprising:
a detection unit for detecting one or more changes in one or more emission characteristics of at least one pair of plasmon-coupled nanoparticles associated with a substrate by detecting one or more changes in one or more emission characteristics of at least one pair of plasmon-coupled nanoparticles associated with a substrate, wherein the substrate comprises at least one pair of plasmon-coupled nanoparticles.

21. The apparatus of claim 20 further comprising an optical energy source to apply an optical energy to the at least one pair of plasmon-coupled nanoparticles to detect the emission characteristics.

22. The apparatus of claim 20 further comprising a processor configured to receive, process, store, or transmit values related to the emission characteristics detected by the detection unit.

23. A sensor comprising:
a membrane disposed on a substrate, the membrane having an exterior surface; and
at least one pair of plasmon-coupled nanoparticles associated with the exterior surface of the membrane.

24. The sensor of claim 23, wherein the exterior surface comprises a reaction agent for interacting with a reaction medium in a manner to deflect the membrane relative to the substrate.

25. The sensor of claim 24, wherein the deflection of the membrane relative to the substrate is detected by one or more changes in one or more emission characteristics of the at least one pair of plasmon-coupled nanoparticles.

26. The sensor of claim 24, wherein the reaction agent comprises a chemical or biomolecular reaction agent.

27. The sensor of claim 24, wherein the reaction medium comprises an analyte.

28. The sensor of claim 23, wherein the membrane comprises a polymer membrane, or an elastomeric membrane.

29. The sensor of claim 23, wherein the pair of nanoparticles are associated with a linker.

30. The sensor of claim 29, wherein the linker comprises a DNA, a RNA, a protein, or a peptide linker.

31. The sensor of claim 23, wherein the nanoparticles comprise gold, silver, copper, titanium, chromium, or a combination of any two or more thereof.

32. The sensor of claim 23, wherein the membrane has a convex or concave shape.

33. A method for detecting deflection of a membrane comprising:
detecting optical characteristics of at least one pair of plasmon-coupled nanoparticles associated with an exterior surface of a membrane, wherein the optical characteristics of the at least one pair of plasmon-coupled nanoparticles change in response to the deflection of the membrane.

34. The method of claim 33, wherein the deflection of the membrane is the result of an interaction between a reaction agent on the exterior surface of the membrane with an analyte.

35. The method of claim 33, wherein detecting optical characteristics of at least one pair of plasmon-coupled nanoparticles comprises providing an electromagnetic energy to the plasmon-coupled nanoparticles, and detecting one or more changes in color emitted from the at least one pair of plasmon-coupled nanoparticles.

36. The method of claim 33, wherein the detecting comprises providing an electromagnetic energy to the plasmon-coupled nanoparticles and detecting one or more changes in the wavelength of the energy emitted from the at least one pair of plasmon-coupled nanoparticles.

37. The method of claim 33, wherein the membrane is deflected in response to a chemical or biomolecular reaction.

38. The method of claim 33, wherein the membrane comprises an elastomeric membrane.

39. The method of claim 33, wherein the nanoparticles comprise gold, silver, copper, titanium, chromium, or a mixture of any two or more thereof.
